(19) United States
(12) Patent Application Publication
(10) Pub. No.: US 2026/0244722 A1
(43) Pub. Date: Aug. 20, 2026

(54) SYSTEM AND METHOD FOR ARTIFICIAL INTELLIGENCE-BASED END DEVICE USER IDENTIFICATION

(71) Applicant: BANK OF AMERICA CORPORATION, Charlotte, NC (US)

(72) Inventors: Vineet Agarwal, Simi Valley, CA (US); Christine D. Black, Brooksville, ME (US); Sanjay Lohar, Mint Hill, NC (US); Jinna Kim, Charlotte, NC (US)

(73) Assignee: BANK OF AMERICA CORPORATION, Charlotte, NC (US)

(21) Appl. No.: 19/054,013

(22) Filed: Feb. 14, 2025

(51) Int. Cl. G06F 21/31

(52) U.S. Cl. CPC G06F 21/316

(57) ABSTRACT

Systems, computer program products, and methods are described herein for Artificial Intelligence-Based End Device User Identification. The present disclosure is configured to receive at least one device input data from a user interaction with a user interface of an end device; determine, using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device; identify unverified input patterns among the device input patterns that do not match the authenticated device input pattern using the AI-based verification module; and execute an unauthorized access response process for the end device when the AI-based user verification module fails to verify the user authentication.

### TECHNOLOGICAL FIELD

Example embodiments of the present disclosure relate to an artificial intelligence (AI)-based end device user identification system.

### BACKGROUND

In modern electronic environments, a single user device may be shared among multiple authorized users. However, the access privileges associated with each user may vary over time. Conventional user authentication mechanisms rely on static credentials, such as a shared password or PIN, which do not inherently differentiate between individual users. As a result, when multiple users utilize the same authentication credentials, the device is unable to distinguish among the multiple users, thereby limiting the ability to enforce user-specific access controls and security policies. Therefor a need exists for a system and method for artificial intelligence-based end device user identification.

### BRIEF SUMMARY

Systems, methods, and computer program products are provided for the AI-based end device user identification.

In one aspect, a system for AI-based end device user identification system is provided. In some embodiments, the system may comprise: a memory device with computer-readable program code stored thereon; and at least one processing device operatively coupled to at least one memory device, wherein executing the computer-readable code is configured to cause at least one processing device to: receive at least one device input data from a user interaction with a user interface of an end device; determine, using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device; identify unverified input patterns among the device input patterns that do not match the authenticated device input pattern during the determination of user authentication to the end device using the AI-based verification module; execute an unauthorized access response process for the end device when the AI-based user verification module fails to verify the user authentication to the end device, wherein the unauthorized access response process comprises suspending the usage of the end device and transmitting a multi-factor authentication request to the user requesting authentication to the end device.

In some embodiments, executing the computer-readable program code is further configured to cause the at least one processing device to execute an update to the end device input database with the unverified input patterns when the AI-based user verification module verifies the user authentication to the end device.

In some embodiments, the AI-based user verification module is configured to: extract a device input pattern associated with user input dynamics from device input data; and verify user authentication to the end device using a pretrained machine learning model configured to determine whether the extracted device input pattern matches an authenticated device input pattern stored in the end device input database

In some embodiments, executing the computer-readable program code is further configured to cause the at least one processing device to trigger the system to start at predefined intervals or in response to predefined events.

In some embodiments, executing the computer-readable program code is further configured to cause the at least one processing device to: determine, using the AI-based user verification module, the user authentication to the user account linked to the end device based on the device input pattern and the end device input database, wherein the device input pattern is extracted from the user device input data and comprise the user input dynamics, and wherein the end device input database comprises at least one authenticated device input pattern authorized for the user account; identify unverified input patterns among the device input patterns that do not match the authenticated device input pattern associated with the user account, during the determination of user authentication to the user account using the AI-based verification module; and execute the unauthorized access response process for the user account or the update to the end device input database with the unverified input patterns, wherein, in an instance where the AI-based user verification module fails to verify the user authentication to the user account, execute the unauthorized access response process for the user account, or wherein, in an instance where the AI-based user verification module verifies the user authentication to the user account, execute an update to the end device input database associated with the user account with the unverified input patterns.

In some embodiments, the device input pattern comprises at least one of: multimodal interaction dynamics recognition, end device usage data, or end device interaction data.

In some embodiments, the unauthorized access response process further comprises transmitting an alert message indicating unauthorized usage of the end device to an administering user.

In some embodiments, the AI-based user verification module is an edge AI, and the end device input database is an on-device database associated with the end device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made to the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for the AI-based end device user identification system, in accordance with an embodiment of the disclosure.

FIG. 2 illustrates an exemplary machine learning (ML) subsystem architecture, in accordance with an embodiment of the invention.

FIG. 3 illustrates a process flow for an end device user verification process, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, camera, webcam, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

A “module” refers to a functional component or unit configured to perform one or more specified tasks. The module may be implemented in hardware, software, firmware, or any combination thereof. In some embodiments, the module may include one or more processors, memory elements, or computer-readable instructions that, when executed, cause the module to perform the described functionality. The module can operate independently or in conjunction with other modules within the system, communicating via predefined interfaces, communication protocols, or data exchange mechanisms. Modules may be arranged in a distributed or centralized architecture and may be dynamically reconfigurable or adaptive to changing conditions or inputs.

In today's electronic environment, a single end device may be shared among multiple authorized users. However, the access permissions for each user may change over time, and the end device cannot distinguish between users, when the users all use the same authentication credentials.

To address this, the present disclosure comprises at least one AI-based end device model for each user associated with the end device or each user account linked to the device. This configuration allows the device to differentiate between users interacting with the end device, even if all users share the same authentication credentials. The system monitors device inputs from user interfaces to recognize user input dynamics in the device inputs during user interactions with the end device. The machine learning model on the end device continuously analyzes device input data to learn and refine these user interaction dynamics. When inputs to the user interface begin, the AI model determines which stored device input pattern best matches the current interaction. Furthermore, by comparing real-time device inputs with stored patterns, the system can detect potential unauthorized access. If an unrecognized user attempts to use the end device, the system may increase authentication requirements (e.g., prompting for additional verification) or block further access altogether.

Accordingly, the present disclosure utilizes an AI-based user verification module to identify device input patterns based on user interactions with the end device and determine user authentication by comparing the input patterns with stored authenticated device input patterns in the database. Based on the determination generated by the AI-based user verification module, the system may execute an unauthorized access response process or update the stored device input patterns.

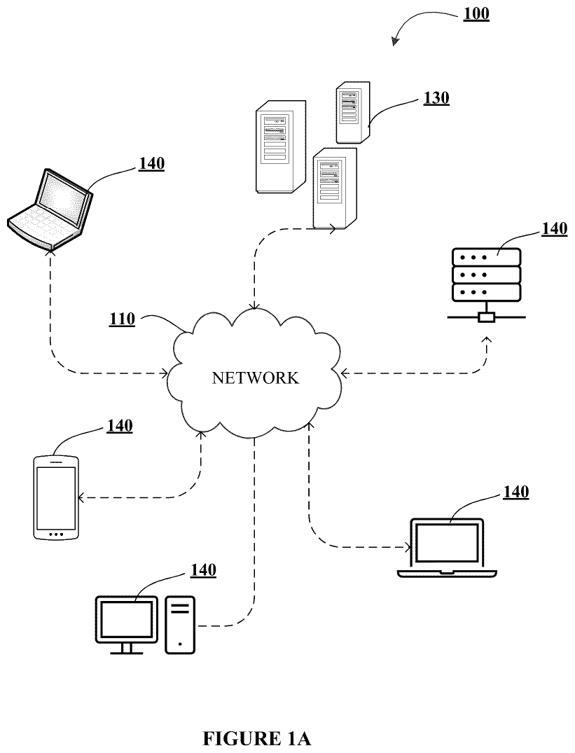

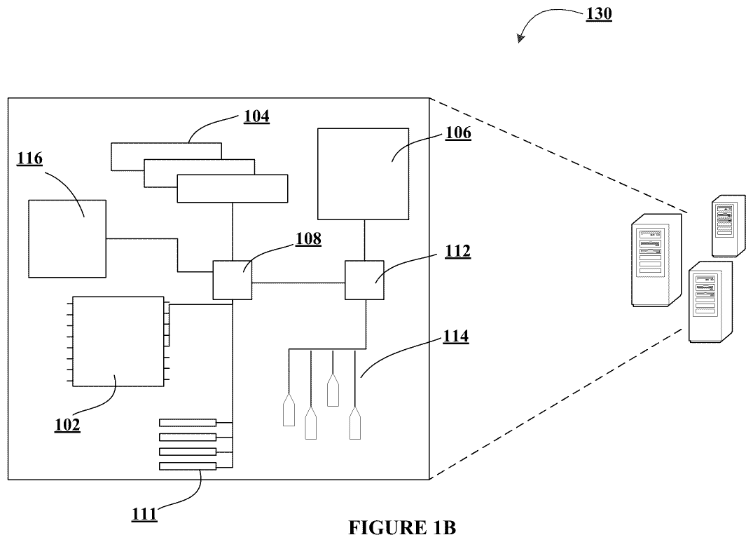

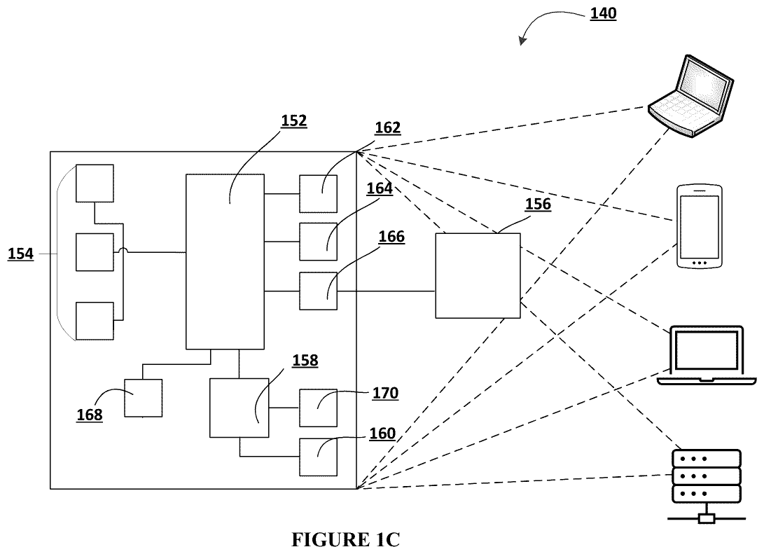

FIGS. 1A-1C illustrate technical components of an exemplary distributed computing environment 100 for the AI-based end device user identification system, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed bus 114 and storage device 106. Each of the components 102, 104, 106, 108, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

In some embodiments, an AI-based end device user identification system may be implanted on the end-point device(s) 140. The memory 154 may store the code of the system, and the processor 152 may execute the code of the system to execute the user verification process.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

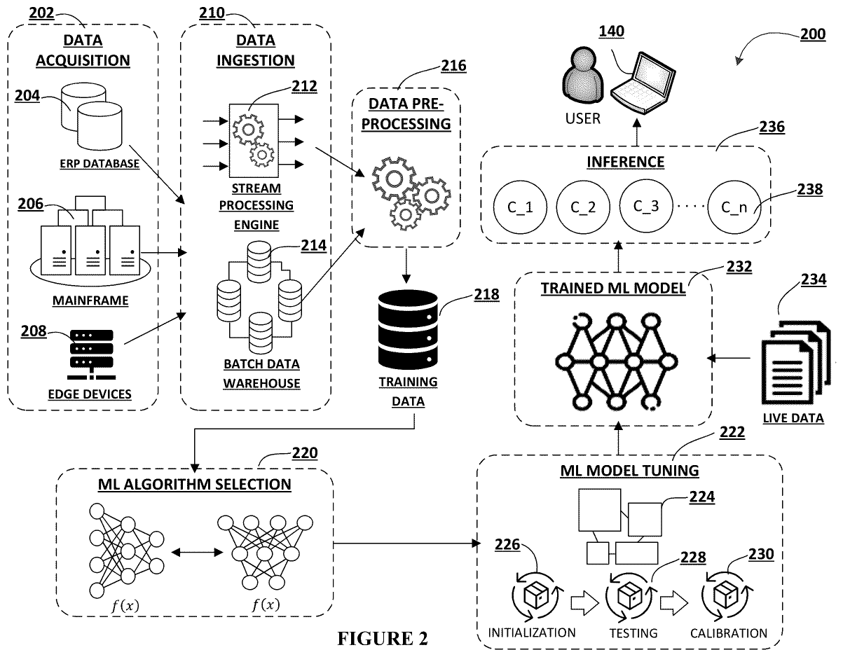

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

In some embodiments, the AI-based end device user identification system may utilize all or part of the machine learning subsystem 200 to execute the user verification process.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

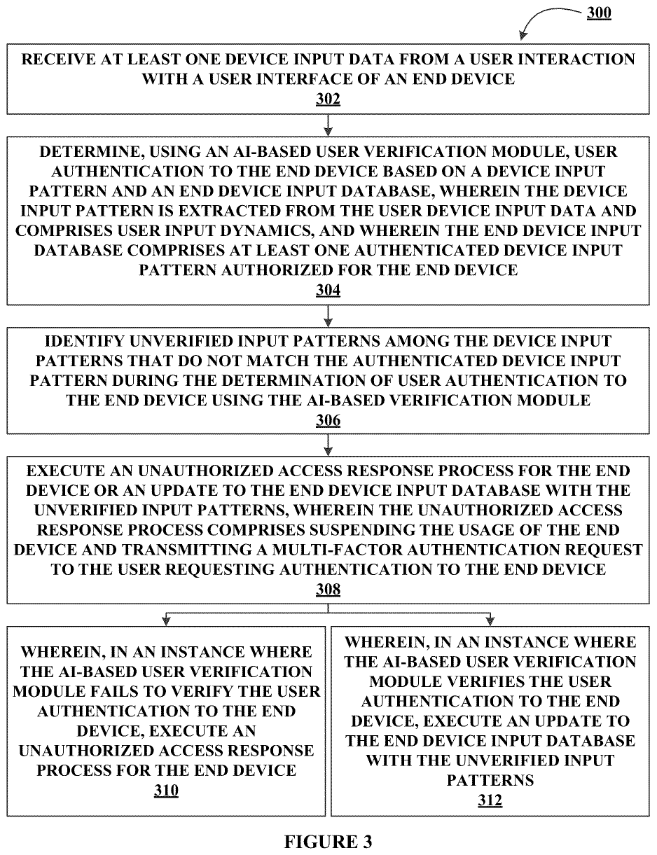

FIG. 3 illustrates a process flow 300 for a user verification process, in accordance with an embodiment of the disclosure. In some embodiments, the system may perform one or more of the steps of process flow 300. For example, the end device user identification system in an end device (e.g., the end-point device(s) 140 described herein with respect to FIG. 1A-1C) and an AI-based user verification module (e.g., the ML model described in FIG. 2) in the end device user identification system may perform some or all of the steps described in process flow 300.

The user may utilize the end device by accessing the end device (e.g., the end-point device(s) 140) or a user account linked to the end device using authentication credentials associated with the user account. In some cases, multiple users may share a common authentication credential to access the end device or the user account. In some embodiments, the end device may be configured to execute the user verification process to identify the user and verify authentication of the user to the end device or the user account.

As shown in block 302, the process flow 300 may include the step of receiving at least one device input data from a user interaction with a user interface of an end device. For example, and as used herein, the “device input data” refers to input data received from user interfaces (e.g., control interface 164) during interactions between the user and the end device. The user identification system may be configured to receive device input data from the user interfaces, wherein the device input data may comprise unique patterns of user interface usage.

As shown in block 304, the process flow 300 may include the step of determining using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device. For example, and in some embodiments, the system may utilize the AI-based user verification module to analyze the device input data from the user interfaces and extract the device input pattern that may comprise the user input dynamics from the interaction with the user interface. Then, the AI-based user verification module may be configured to identify the user and determine user authentication to the end device using a pretrained ML model based on the device input pattern and the authenticated device input patterns stored in the end device input database from the past user verification process.

In some embodiments, the device input patterns that are identified with the AI-based user verification module may comprise a multimodal interaction dynamics recognition, end device usage data, or end device interaction data. The multimodal interaction dynamics recognition may be extracted from interactions with the user interfaces, such as keyboard input patterns (e.g., typing speed, keypress durations, rhythms, errors, and/or the like), mouse movement patterns (e.g., double clicking speed, hovering pattern, cursor movement speed, and/or the like), touchscreen gesture input patterns (e.g., tap duration, duration between double tapping, and/or the like), microphone inputs (e.g., airflow patterns, frequency range and pitch variations in the speech), camera inputs (e.g., movement around the screen, and/or the like), and/or the like. The end device usage data may be extracted from the user interactions with the end device, such as usage of frequently used software or applications, application usage sequences, location and time-based patterns, and/or the like. The end device interaction data may be extracted from the user interaction with software or applications in the end device, such as navigation patterns on applications, preferences or choices (e.g. frequent menu selections, hot keys, and/or the like), application usage times and durations, scrolling speed, reading speed, unique settings (e.g., dark mode vs. light mode, keyboard shortcuts, and/or the like), and/or the like.

In some embodiments, the AI-based user verification module may analyze the device input data to identify the device input patterns using machine learning (ML) models or algorithms (e.g., machine learning algorithm 220). Such ML algorithms may be selected from: supervised learning algorithms, such as Decision Trees, Random Forests, Support Vector Machines (SVM), Gradient Boosting, and/or the like; unsupervised learning algorithms, such as K-means, Density-Based Spatial Clustering of Applications with Noise (DBSCAN), and/or the like; or deep learning algorithms, such as Recurrent Neural Networks (RNN), Long Short-Term Memory (LSTM) networks, transformers, and/or the like; Time-Series analysis algorithms, such as Hidden Markov Models (HMM), Dynamic Time Warping (DTW), temporal convolutional networks, and/or the like; or feature extraction models algorithms, such as Autoencoders, Principal Component Analysis (PCA), and/or the like. Moreover, the AI-based user verification module may be configured to use multimodal ML algorithms that combines multiple sources of device input data from the user interfaces.

In some embodiments, the end device input database may comprise user authentication information for software applications installed on the end device, the user account linked to the end device, and the end device itself. For instance, the database may store lists of authorized users for applications or software installed on the end device, the user account linked to the end device, and the end device. For each user, the database may store device input patterns that are updated by the system or by external authentication systems that manage the user authentication information. Furthermore, the list of authorized users may be updated by administering users or external authentication systems.

In some embodiments, the AI-based user verification module may determine the verification of the user authentication using ML algorithms (e.g., machine learning algorithm 220). Such ML algorithms may be selected from anomaly detection algorithms, such as one-class Support Vector Machine (SVM), Isolation Forests, Neural Networks for Anomalies, and/or the like. The AI-based user verification module detects anomalies in the device input pattern derived from the device input data by comparing authorized device input pattern stored on the end device input database.

In some embodiments, the system may utilize the AI-based user verification module employing reinforcement learning models, such as Multi-Armed Bandits, Deep Q-Learning, Policy Gradient methods, and/or similar techniques, to adjust parameters within the reinforcement learning models based on user feedback (e.g., receiving confirmation of the user authentication from the user using a Multi-Factor Authentication process).

As shown in block 306, the process flow 300 may include the step of identifying unverified input patterns among the device input patterns that do not match the authenticated device input pattern during the determination of user authentication to the end device using the AI-based verification module. For example, and in some embodiments, the AI-based user verification module may detect device input patterns that is not matching with the authenticated device input patterns stored in the end device input database. The detected device input patterns are classified as the unverified input patterns.

As shown in block 308 and block 310, the process flow 300 may include the step of executing an unauthorized access response process for the end device when the AI-based user verification module fails to verify the user authentication to the end device, wherein the unauthorized access response process comprises suspending the usage of the end device and transmitting a multi-factor authentication request to the user requesting authentication to the end device. For example, and in some embodiments, the AI-based user verification module may reject the user authentication to the end device based on the unverified input patterns. The rejection of the user authentication may trigger the system to execute the unauthorized access response process to restrict the usage of the end device from current user using the end device.

In some embodiments, the unauthorized access response process may comprise generating and transmitting a notification indicating the failure of the user authentication. The notification may be transferred to the user via the end device or transferred to the administering user, a system administrator, a security monitoring service, or an external security management server. The notification may comprise detail information of the unauthorized access, such as timestamps, end device identifier, user account identifier, software or application identifiers, and/or the like.

In certain embodiments, the unauthorized access response process may further comprise restricting access to the end device following the user authentication failure. The access restriction may be enforced by implementing a temporary or permanent account lockout, thereby preventing further authentication attempts for a predefined duration. In another embodiment, upon rejection of authentication, the unauthorized access response process may prompt an additional security verification step. The system may require the Multi-Factor Authentication (MFA), a One-Time Passcode (OTP) sent via electronic communication to the authorized users, or an authentication challenge question before allowing subsequent login attempts. In some embodiments, the unauthorized access response process may incorporate data protection mechanisms to mitigate perils of unauthorized access. The system may initiate a secure encryption protocol to restrict access to sensitive data, revoke active session keys.

As shown in block 308 and block 312, the process flow 300 may include the step of executing an update to the end device input database with the unverified input patterns, when the AI-based user verification module verifies the user authentication to the end device. For example, and in some embodiments, the system may be configured to update unverified input patterns that deviate from the stored authenticated device input patterns in the end device input database upon verification of the user authentication by the AI-based user verification module based on device input patterns that align with the stored device input patterns in the end device input database.

In some embodiments, the system may be configured to update unverified input patterns in the end device input database upon receiving user feedback permitting verification. The user feedback may comprise, for example, a Multi-Factor Authentication process initiated by the user, authorization from an administering user, and/or similar verification methods. The updated device input patterns may subsequently be utilized in future user verification processes.

In some embodiments, the system may be configured to initiate the user verification process when the user begins utilizing the end device. Then, the user verification process may execute as a background application during the user's interaction with the end device. In some embodiments, the user identification system may be triggered to execute the user verification process at predefined intervals (e.g., every 10 minutes or at random intervals). Furthermore, the user verification process may be triggered upon the occurrence of a predefined event, such as the launch of a predefined software or application, prior to executing a sensitive process, and/or the like.

In some embodiments, the user identification system may be configured to execute the user verification process at a user account level or an application level. For example, the AI-based user verification module may be configured to determine user verification for a user account linked to the end device or for predefined applications installed on the end device. The end device input database may store device input patterns associated with authorized users of the user account or the predefined software applications.

In some embodiments, the user identification system may be configured to utilize an edge AI system, wherein the end device input database is an on-device database associated with the end device. Such a configuration ensures security and data privacy by confining the user verification process within the end device.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for Artificial Intelligence (AI)-based end device user identification, the system comprising:
a memory device with computer-readable program code stored thereon; and
at least one processing device operatively coupled to at least one memory device, wherein executing the computer-readable code is configured to cause at least one processing device to:
receive at least one device input data from a user interaction with a user interface of an end device;
determine, using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device;
identify unverified input patterns among the device input patterns that do not match the authenticated device input pattern during the determination of user authentication to the end device using the AI-based verification module; and
execute an unauthorized access response process for the end device when the AI-based user verification module fails to verify the user authentication to the end device, wherein the unauthorized access response process comprises suspending usage of the end device and transmitting a multi-factor authentication request to user to request authentication to the end device.

2. The system of claim 1, wherein executing the computer-readable program code is further configured to cause at least one processing device to:
execute an update to the end device input database with the unverified input patterns when the AI-based user verification module verifies the user authentication to the end device.

3. The system of claim 1, wherein the AI-based user verification module is configured to:
extract device input patterns associated with user input dynamics from device input data; and
verify user authentication to the end device using a pretrained machine learning model configured to determine whether the extracted device input pattern matches an authenticated device input pattern stored in the end device input database.

4. The system of claim 1, wherein executing the computer-readable program code is further configured to cause at least one processing device to trigger the system to start at predefined intervals or in response to predefined events.

5. The system of claim 1, wherein executing the computer-readable program code is further configured to cause at least one processing device to:
determine, using the AI-based user verification module, the user authentication to the user account linked to the end device based on the device input pattern and the end device input database, wherein the device input pattern is extracted from the user device input data and comprise the user input dynamics, and wherein the end device input database comprises at least one authenticated device input pattern authorized for the user account;
identify unverified input patterns among the device input patterns that do not match the authenticated device input pattern associated with the user account, during the determination of user authentication to the user account using the AI-based verification module; and
execute the unauthorized access response process for the user account or an update to the end device input database with the unverified input patterns,
wherein, in an instance where the AI-based user verification module fails to verify the user authentication to the user account, execute the unauthorized access response process for the user account, or
wherein, in an instance where the AI-based user verification module verifies the user authentication to the user account, execute an update to the end device input database associated with the user account with the unverified input patterns.

6. The system of claim 1, wherein the device input pattern comprises at least one of: multimodal interaction dynamics recognition, end device usage data, or end device interaction data.

7. The system of claim 1, wherein the unauthorized access response process further comprises transmitting an alert message indicating unauthorized usage of the end device to an administering user.

8. The system of claim 1, wherein the AI-based user verification module is an edge AI, and the end device input database is an on-device database associated with the end device.

9. A computer program product for an Artificial Intelligence (AI)-based end device user identification system, wherein the computer program product comprises at least one non-transitory computer-readable medium having computer-readable program code portion embodied therein, the computer-readable program code portions which when executed by a processing device are configured to cause a processor to:
receive at least one device input data from a user interaction with a user interface of an end device;
determine, using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device;
identify unverified input patterns among the device input patterns that do not match the authenticated device input pattern during the determination of user authentication to the end device using the AI-based verification module; and
execute an unauthorized access response process for the end device when the AI-based user verification module fails to verify the user authentication to the end device, wherein the unauthorized access response process comprises suspending usage of the end device and transmitting a multi-factor authentication request to user to request authentication to the end device.

10. The computer program product of claim 9, wherein the processing device is further configured to:
execute an update to the end device input database with the unverified input patterns when the AI-based user verification module verifies the user authentication to the end device.

11. The computer program product of claim 9, wherein the AI-based user verification module is configured to:
extract device input patterns associated with user input dynamics from device input data; and
verify user authentication to the end device using a pretrained machine learning model configured to determine whether the extracted device input pattern matches an authenticated device input pattern stored in the end device input database.

12. The computer program product of claim 9, wherein the processing device is further configured to:
determine, using the AI-based user verification module, the user authentication to the user account linked to the end device based on the device input pattern and the end device input database, wherein the device input pattern is extracted from the user device input data and comprise the user input dynamics, and wherein the end device input database comprises at least one authenticated device input pattern authorized for the user account;
identify unverified input patterns among the device input patterns that do not match the authenticated device input pattern associated with the user account, during the determination of user authentication to the user account using the AI-based verification module; and
execute the unauthorized access response process for the user account or an update to the end device input database with the unverified input patterns,
wherein, in an instance where the AI-based user verification module fails to verify the user authentication to the user account, execute the unauthorized access response process for the user account, or
wherein, in an instance where the AI-based user verification module verifies the user authentication to the user account, execute an update to the end device input database associated with the user account with the unverified input patterns.

13. The computer program product of claim 9, wherein the device input pattern comprises at least one of: multimodal interaction dynamics recognition, end device usage data, or end device interaction data.

14. The computer program product of claim 9, wherein the AI-based user verification module is an edge AI, and the end device input database is an on-device database associated with the end device.

15. A computer-implemented method for an Artificial Intelligence (AI)-based end device user identification system, the method comprising:
receiving at least one device input data from a user interaction with a user interface of an end device;
determining, using an AI-based user verification module, user authentication to the end device based on a device input pattern and an end device input database, wherein the device input pattern is extracted from the user device input data and comprises user input dynamics, and wherein the end device input database comprises at least one authenticated device input pattern authorized for the end device;
identifying unverified input patterns among the device input patterns that do not match the authenticated device input pattern during the determination of user authentication to the end device using the AI-based verification module; and
executing an unauthorized access response process for the end device when the AI-based user verification module fails to verify the user authentication to the end device, wherein the unauthorized access response process comprises suspending usage of the end device and transmitting a multi-factor authentication request to user to request authentication to the end device.

16. The computer-implemented method of claim 15, wherein the computer-implemented method is further configured for:
executing an update to the end device input database with the unverified input patterns when the AI-based user verification module verifies the user authentication to the end device.

17. The computer-implemented method of claim 15, wherein the AI-based user verification module is configured for:
extracting device input patterns associated with user input dynamics from device input data; and
verifying user authentication to the end device using a pretrained machine learning model configured to determine whether the extracted device input pattern matches an authenticated device input pattern stored in the end device input database.

18. The computer-implemented method of claim 15, wherein the computer-implemented method is further configured for:
determining, using the AI-based user verification module, the user authentication to the user account linked to the end device based on the device input pattern and the end device input database, wherein the device input pattern is extracted from the user device input data and comprise the user input dynamics, and wherein the end device input database comprises at least one authenticated device input pattern authorized for the user account;
identifying unverified input patterns among the device input patterns that do not match the authenticated device input pattern associated with the user account, during the determination of user authentication to the user account using the AI-based verification module; and
executing the unauthorized access response process for the user account or an update to the end device input database with the unverified input patterns,
wherein, in an instance where the AI-based user verification module fails to verify the user authentication to the user account, executing the unauthorized access response process for the user account, or
wherein, in an instance where the AI-based user verification module verifies the user authentication to the user account, executing an update to the end device input database associated with the user account with the unverified input patterns.

19. The computer-implemented method of claim 15, wherein the device input pattern comprises at least one of: multimodal interaction dynamics recognition, end device usage data, or end device interaction data.

20. The computer-implemented method of claim 15, wherein the AI-based user verification module is an edge AI, and the end device input database is an on-device database associated with the end device.
